(19) United States
(12) Patent Application Publication
(10) Pub. No.: US 2005/0257201 A1
(43) Pub. Date: Nov. 17, 2005

(54) Optimization of XPath expressions for evaluation upon streaming XML data

(75) Inventors: Kristoffer H. Rose, Poughkeepsie, NY (US); Pierre Geneves, Meylan (FR)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/847,405

(22) Filed: May 17, 2004

(51) Int. Cl. G06F 9/45

(52) U.S. Cl. 717/136

(57) ABSTRACT

A method, information processing system and computer readable medium for processing a full XPath expression for evaluation over streaming XML data is disclosed. The method includes transforming the full XPath expression into an equivalent XPath expression written in a reduced XPath language and transforming context position information in the equivalent XPath expression into an expression for computing the context position information. The method further includes transforming reverse axis information in the equivalent XPath expression into forward axis information, wherein an evaluation of the equivalent XPath expression over streaming XML data is facilitated.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of Extensible Markup Language (XML) and more particularly relates to the field of evaluation of XPath (a language for addressing XML documents) expressions upon streaming XML data.

### BACKGROUND OF THE INVENTION

“eXtensible Markup Language” (XML) is a textual notation for a class of data objects called “XML Documents” and partially describes a class of computer programs processing them. A characteristic of XML documents is that they have a principal rooted tree data structure with “element nodes” as the main construction. Element nodes have a tag name, can have associated named attribute values, and can have “child” nodes. In addition to element nodes without children, the leaves of an XML tree structure can contain character data in various forms (specifically text, comments, and special “processing instruction” nodes).

“XML Path Language” (XPath) is a notation for describing a selection of nodes in XML data, as well as for performing (basic) computations over the values stored in the nodes. XPath is used to “navigate” XML data in “steps” that each move the “focus” from one node to another. The language for specifying steps is rich with regards to the type of node associations used to navigate between nodes, in order to facilitate reaching any focus of interest from any other node.

XPath has been widely accepted in many environments, especially in database environments. In fact, query languages such as XSLT, SQLX, and XQuery include XPath as a sublanguage. Given the importance of XPath as a mechanism for querying and navigating data, it is important that the evaluation of XPath expressions on XML documents be as efficient as possible. Ideally, the evaluation algorithm will traverse the XML document as little as possible before returning the result of the query.

The evaluation of an XPath expression is defined in terms of a tree structure representation of an XML document. A tree is a data structure composed of nodes. One of the nodes is specially designated to be the root node. All nodes in the tree other than the root node have exactly one parent node in the tree. An XML document can be represented as a labeled tree whose nodes represent the structural components of the document—elements, text, attributes, comments, and processing instructions. Element and attribute nodes have labels derived from the corresponding tags in the document and there may be more than one node in the document with the same label. Parent-child edges in the tree represent the inclusion of the child component in its parent element, where the scope of an element is bounded by its start and end tags. The tree corresponding to an XML document is rooted at a virtual element, root, which contains the document element. We will, henceforth, discuss XML documents in terms of their tree representation. One can define an arbitrary order on the nodes of a tree. One such order might be based on a left-to-right depth-first traversal of the tree, which, for a tree representation of an XML document, corresponds to the document order.

Given an order on a tree, we can define a notion of a forward and backward relation on a tree. A relation R is a forward relation if whenever two nodes x and y are related by R, it must be the case that x precedes y in the order on the tree. Similarly, a relation is a backward relation if whenever x is related to y, then it must be the case that x follows y in the order on the tree. For example, assuming the document order for a tree representation of an XML document, the child and descendant relations are both forward relations, whereas the parent and ancestor relations are both backward relations.

An XPath expression over the tree representation of an XML document is evaluated in terms of a context node. The context node is a node in the tree representation of the document. If the context node is the root node of the document, the XPath expression is said to be an absolute XPath expression, otherwise, it is known as a relative XPath expression. Starting at a context node, an XPath expression specifies the axis to search and conditions that the results should satisfy. For example, assume that the context node is an element node c in the tree representation of an XML document. The XPath expression descendant::x specifies that starting from c, search all descendants of c and return all element nodes with label x. In this expression, “descendant” is the axis that is searched. One can compose XPath expressions to form larger XPath expressions. For example, the XPath expression descendant::x/ancestor::y specifies that starting from the context node c, find all element nodes that are descendants of c with label x, and for each such node, find all ancestor nodes with label y.

In traditional XPath processing, the XML document, over which XPath expressions are to be evaluated, is processed and a tree representation is built in memory. In evaluating an XPath expression over this in-memory tree representation of an XML document, an XPath processor, such as Xalan, may make several passes over the XML document. In the worst case, the number of passes over the XML document may be exponential in the size of the XPath expression (Georg Gottlob, Christoph Koch, Reinhard Pichler: Efficient Algorithms for Processing XPath Queries. VLDB 2002: 95-106). In many circumstances, for example, for large XML documents stored on a disk in a database, these multiple traversals can be prohibitively expensive. Xalan is an XSLT processor for transforming XML documents into HTML, text, or other XML document types. Xalan uses an apache implementation of XPath and the related XSLT standard based on the premise that the XML document is first stored in computer memory in a way that allows arbitrary traversal of the nodes. It implements XSL Transformations (XSLT) Version 1.0 and XML Path Language (XPath) Version 1.0. It can be used from the command line, in an applet or a servlet, or as a module in another program.

To alleviate the complexity issue mentioned in the previous paragraph, streaming XPath evaluation algorithms have been developed that return a query result after exactly one pass over an XML document or tree. Streaming processing is a type of processing of data in which the data does not have to be stored in memory but is instead read sequentially in small chunks, typically called “events”, in some predefined order (usually “left-to-right” corresponding to the left-to-right order of the textual representation of the data). XPath processing over XML involves the evaluation of an XPath expression over streaming XML.

The following commonly-owed U.S. patent applications include subject matter related to the evaluation of transformed XPath expressions over streaming XML: U.S. patent application Ser. No. 10/752,624, filed on Jan. 7, 2004 and entitled “Streaming Mechanisms for Efficient Searching of In-Memory Tree,” and U.S. patent application Ser. No. 10/264,076, filed on Oct. 3, 2002 and entitled “A Method for Streaming XPath Processing with Forward and Backward Axes.” The aforementioned U.S. patent applications are hereby incorporated by reference in their entirety.

A streaming XPath engine is structured as shown in FIG. 1. An XPath expression 111 is analyzed and represented as an automaton 103. The XPath engine 101 consumes events (for example, SAX events) produced by a parser 105, and for each event, the automaton 103 may make state transitions, and if necessary, store the element. At the conclusion of, or during, the processing of the document 107, the XPath engine returns the list, or a partial list, of elements 109 that are the result of the evaluation of the XPath expression 111.

Algorithms for processing streaming XPath expressions are generally limited to absolute XPath expressions containing only forward axes (child and descendant axes). Discussing a related technology, U.S. patent application Ser. No. 10/264,076 entitled “A Method for Streaming XPath Processing with Forward and Backward Axes” by Charles Barton, Philippe Charles, Deepak Goyal, and Mukund Raghavachari, Proceedings of IEEE International Conference on Data Engineering, March 2003, presents a novel modification allowing streaming algorithms to handled both forward and backward axes (parent and ancestor) efficiently. More information is detailed in “Streaming XPath Processing with Forward and Backward Axes” by Charles Barton, Philippe Charles, Deepak Goyal, Mukund Raghavachari, Marcus Fontoura, and Vanja Josifovski, cited above. A novel representation of a data structure called an X-DAG makes this possible. An X-DAG is a data structure in which all occurrences of backward axes are converted into forward constraints, thereby making streaming XPath processing possible.

A limitation of this streaming algorithm is that, like other streaming algorithms, it only handles absolute XPath expressions. In practice, however, relative XPath expressions are more prevalent. To improve the efficiency of XPath processing it is important to devise streaming techniques for evaluating relative XPath expressions with both forward and backward axes in at the most one traversal of an XML document or tree.

Current streaming algorithms always traverse the entire XML document (exactly once) to evaluate an XPath expression over an XML document. In many cases, however, by ordering the XML document appropriately, it is possible to minimize the amount of the document traversed. When a relative expression is evaluated with respect to the context node c, it is more likely that the nodes around c will be relevant to the result than nodes in the tree that are far away from c. By reordering the traversal of the tree so that such nodes are traversed first, one can minimize the number of nodes traversed in many cases. For example, for the XPath expression descendant::x evaluated with respect to the context node c, we would only like to traverse the descendants of c and avoid traversal of the rest of the XML document. In general, such reorderings must handle complex XPath expressions involving ancestor and descendant axes, and integrate any such reordering into the streaming algorithm in a clean manner so that the algorithm still functions correctly.

Further, since XPath allows any conceivable access policy, current mainstream XPath implementations, such as Xalan, implement XPath by copying the entire XML data contents into a linked memory structure such as the Document Object Model that easily supports the full XPath language (See R. Whitmer, Document Object Model (DOM) Level 3 XPath Specification, W3C Working Group Note, February 2004). Indeed many cite this as a reason for not using XPath at all but instead inventing and using a subset that can be efficiently implemented on top of the desired data structure. The sequential or streaming case has attracted attention as this is the natural access policy for generic textual XML files. Work has also been undertaken to attempt to adapt and optimize general XPath to specific data access policies in the form of schema constraints or to streaming. However, these adaptations are rather complicated because of the size of the XPath language.

Therefore, a need exists to overcome the problems with the prior art as discussed above, and particularly for a way to more efficiently evaluate XPath expressions upon streaming XML data.

### SUMMARY OF THE INVENTION

Briefly, according to an embodiment of the present invention, a method for processing a full XPath expression for evaluation over streaming XML data is disclosed. The method includes transforming the full XPath expression into an equivalent XPath expression written in a reduced XPath language. The method further includes transforming context position information in the equivalent XPath expression into an expression for computing the context position information and transforming reverse axis information in the equivalent XPath expression into forward axis information.

Also disclosed is an information processing system for processing a full XPath expression for evaluation over streaming XML data. The information processing system includes a memory for storing the full XPath expression and a processor configured to transform the full XPath expression into an equivalent XPath expression written in a reduced XPath language. The processor is further configured to transform context position information in the equivalent XPath expression into an expression for computing the context position information and transform reverse axis information in the equivalent XPath expression into forward axis information.

The method can also be implemented as machine executable instructions executed by a programmable information processing system or as hard coded logic in a specialized computing apparatus such as an application-specific integrated circuit (ASIC). Thus, also disclosed is a computer readable medium including computer instructions for processing a full XPath expression for evaluation over streaming XML data. The computer readable medium includes instructions for transforming the full XPath expression into an equivalent XPath expression written in a reduced XPath language. The computer readable medium further includes instructions for transforming context position information in the equivalent XPath expression into an expression for computing the context position information and transforming reverse axis information in the equivalent XPath expression into forward axis information.

In another embodiment of the present invention, a method for processing an expression for evaluation over streaming XML data is disclosed. The method includes transforming the expression into an equivalent expression written in a reduced language and transforming context position information in the equivalent expression into an expression for computing the context position information. The method further includes transforming reverse axis information in the equivalent expression into forward axis information. The expression is written in any one of the XPath language and a language that allows access to and navigation in XML or similar tree-structured data based on relative and absolute positions and navigation.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram of the structure of an XPath processor for evaluating XPath expressions upon streaming XML data, according to the prior art.

FIG. 2 is a simplified representation of an XML document in tree form.

FIG. 3 is a block diagram showing the control flow of the process of one embodiment of the present invention.

FIG. 4 is an illustration of an XML tree showing axis partitions for a context node.

FIG. 5 is a representation of a derivor used for transforming an XPath expression in to a state-less form, in one embodiment of the present invention.

FIG. 6 is a representation of a derivor used for transforming an XPath expression in to a forward-only form, in one embodiment of the present invention.

FIG. 7 is a high level block diagram showing an information processing system useful for implementing one embodiment of the present invention.

### DETAILED DESCRIPTION

We discuss an algorithm which allows for the efficient evaluation of a fully expressive XPath expression with either or both forward and backward axes over streaming XML data. Efficiency is guaranteed by allowing at most one traversal of the streaming XML data. Additionally, the present invention allows for the transformation of a full XPath expression in to a state-less and forward-only form, allowing for the quick and easy evaluation of the transformed XPath expression over streaming XML data.

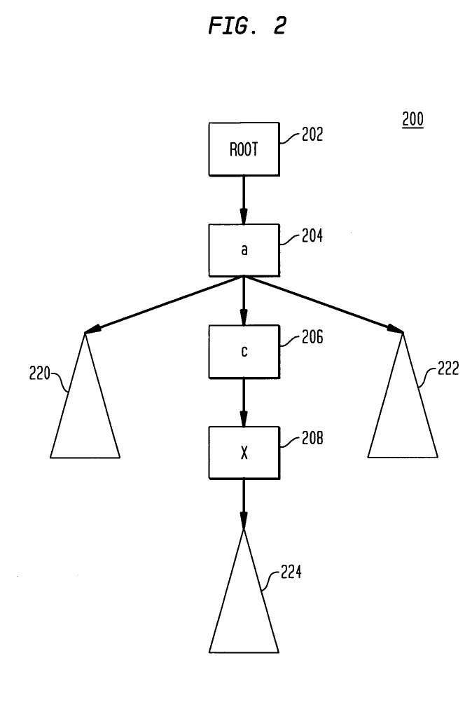

FIG. 2 illustrates a tree structure representation of a portion of an XML document. For simplicity, we focus on elements and ignore such items as attributes and text nodes. The tree 200 therefore, consists of the virtual root 202 and the elements of the document. To avoid confusion between the XML document tree 200 and a tree representation of the XPath, we use elements to refer to the nodes of the XML tree 200. The root 202 has a descendant 204 labeled “a” having two subtrees 220 and 222 and a descendant 206 labeled “c,” which in turn has a descendant 208 having an element “X.” The element 208 has a subtree 224. Note that in general the subtrees contain one or more elements, which are not shown. We shall assume that the element 208, labeled “X”, is the context node to be used for XPath expressions.

The described embodiments of the present invention are advantageous as they allow for the quick and easy transfer of data from one application to another. This results in a more pleasurable and less time-consuming experience while word processing or otherwise editing a document on an information processing system. Another advantage of the present invention is the reduction in the number of steps necessary for effectuating the copy and paste process. This results in increased usability and user-friendliness of the information processing system on which the word processing or document editing is being performed.

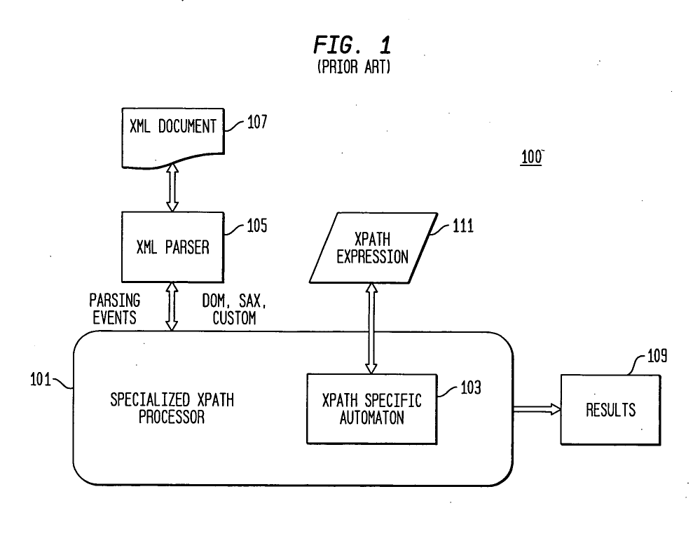

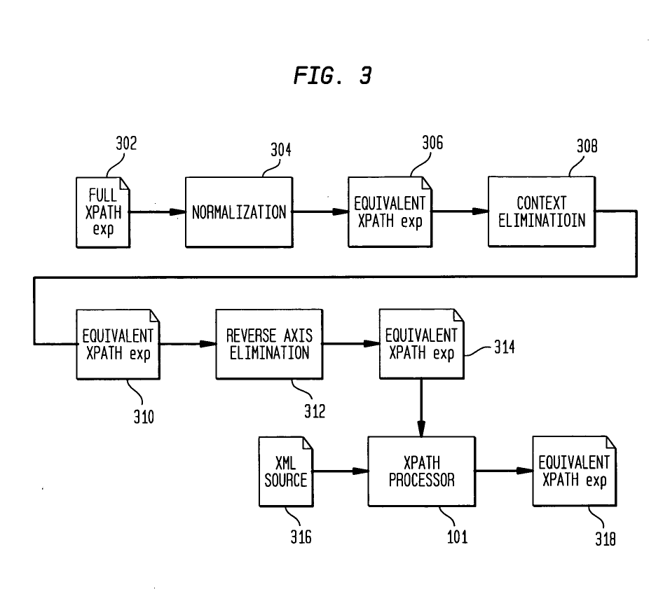

FIG. 3 is a block diagram showing the control flow of the process of one embodiment of the present invention. FIG. 3 shows the process by which a full XPath expression is transformed into a state-less, forward-only subset and subsequently evaluated by an XPath processor (such as the one described with reference to FIG. 1) upon streaming XML data. The control flow depicted in FIG. 3 begins with a full XPath expression 302. As described above, a full XPath expression refers to an XPath expression written in the full XPath language, which is defined by the World Wide Web Consortium (W3C)—an international association organized for developing and maintaining common web protocols and ensuring their interoperability.

As a running example, take the following full XPath expression:
/descendant::employee/ancestor::manager[1]

The above example of a full XPath expression enumerates all employee elements that are descendants of the context node and then collects for each the closest manager ancestor element. Note that the context state is included in the above expression and a backward axis is referenced. The evaluation of the example expression is explained in greater detail below.

The full XPath expression 302 is processed by the normalization module 304, which transforms the full XPath expression into an equivalent XPath expression written in a reduced XPath language, which is a simplified version of the full XPath language. A reduced XPath language is a minimal but fully expressive subset of the full XPath language. That is, a reduced number of constructs or semantics of the full XPath language are used in a reduced XPath language, without losing any of the expressiveness of the full XPath language.

In an embodiment of the present invention, the normalization module 304 transforms the full XPath expression 302 into an equivalent XPath expression 306 written in any of a variety of reduced XPath languages. These include the XPath core language (a reduced XPath language defined in D. Draper et al., XQuery 1.0 and XPath 2.0 Formal Semantics, W3C Working Draft, August, 2003), the Restricted XPaths—Rxp language (a reduced XPath language defined in C. Barton et al., Streaming XPath Processing with Forward and Backward Axes, ICDE—International Conference on Data Engineering, Bangalore, India, March, 2003), the STX language (a reduced XPath language defined in O. Becker, Extended SAX Filter Processing with STX, Extreme Markup Languages, Aug. 4-8, 2003) and the SXPath language (a reduced XPath language defined in A. Desai, Introduction to Sequential XPath, Proc. of IDEAlliance XML Conference, 2001). For purposes of the running example, the normalization module 304 uses the XPath core language as the reduced XPath language.

The normalization module 304 rewrites or transforms the full XPath expression 302 to the equivalent and fully expressive (but more verbose and explicit) reduced (or core, in the example) XPath expression 306 shown below:

```
ddo(
    let $seq := $root/descendant::employee
    return
      for $dot in $seq
      return
          let $seq := ddo($dot/ancestor::manager)
          return
            let $last := count($seq)
            return
                for $dot at $rpos in $seq
                return
                  let $pos := $last − $rpos + 1
                  return
                      if $pos eq 1 then $dot else ( )
)
```

The equivalent XPath expression 306 was obtained from the full XPath expression 302 by executing a series of four steps. In a first step, the initial “/descendant::employee” fragment searching for all employee element nodes was normalized into the reduced expression fragment:

```
let $seq := $root/descendant::employee
return
      for $dot in $seq
      return
```

This fragment explicitly names the initial context sequence $seq as a descendant search starting from the (implicitly declared) root node $root and then explicitly initiates an iteration over the nodes in this sequence, binding each as the context node to $dot for the subsequent code.

In a second step, the subsequent “/ancestor::manager” fragment searching for all manager ancestor element nodes for each of the context nodes is then expressed as the reduced fragment:

```
let $seq := ddo($dot/ancestor::manager)
return
      let $last := count($seq)
      return
            for $dot at $rpos in $seq
            return
                  let $pos := $last − $rpos + 1
                  return
```

This fragment similarly constructs a new context sequence $seq with all ancestor nodes of the context node $dot that are manager elements and reorders it in document order (which is what the ddo function application accomplishes). The fragment furthermore explicitly defines $last as the context size, i.e., the length of the context sequence (using the count function), and then iterates over the context sequence as before, binding $dot to the context node and $rpos to the context position in each case for each of the nodes in $seq. Since we will later be using the reverse context position (see below) we then calculate and bind to $pos the position from the end of the context node. Notice that the binding of $seq in this core fragment hides the binding of $ seq in the previous core fragment.

In a third step, the last “[1]” in the expression is an XPath short-hand for “select only the closest ancestor among those found,” which normalizes into the reduced expression fragment:
if $pos eq 1 then $dot else ( )

This reduced fragment expresses that if the context position from the end is 1, i.e., when the context node was the last one, the result of this iteration should contribute an instance of the context node $dot, otherwise nothing, written ( ), is contributed. This is where the reference to the context state resides: the variable $pos, generated by normalization from the XPath pseudo-function position ( ), denotes the context position.

In a fourth step, a generic rule is followed. This rule for composite XPath “path expressions” requires that the result should be in document order with no duplicates, which is ensured by the outermost designators:

ddo(
. . .
)

Like the original XPath expression 302, the normalized expression 306 involves one use of a reverse axis, ancestor, and one use of the context position, present as the “at $rpos” in the last for expression that binds the name $rpos to the current position of the node in the sequence being processed by the for expression and subsequently used to compute the $pos context position.

The full core language and the precise normalization rules are given in the XPath/XQuery formal semantics (See D. Draper et al.). Below is a subset of normalization rules used by the normalization module 304.

The rule “let $v :=Expr₁ return Expr₂” computes the first expression, Expr₁, and then computes the second expression, Expr₂ with the variable $v bound to the value computed for the first expression.

The rule “for $dot at $pos in $seq return Expr” iterates over the sequence bound to $seq and concatenates the results of computing the expression, Expr, with $dot bound to each of the members of the sequence value, in order, and $pos bound to the index number of each member in the sequence.

The rule “if Expr₁ then Expr₂ else Expr₃” computes Expr₁ and, depending on the truth value, returns the result of computing either Expr₂ or Expr₃.

The rule “<<” is a binary test of whether two nodes are in left-to-right document order.

The rule “intersect” is a binary node operation that constructs the intersection of the operand node sequences. The result is in document order without duplicates.

The rule “( )” denotes the empty sequence, similar to “/ . . . ” in XPath 1.

The rule “ddo (Expr)” is equivalent to “(Expr intersect Expr)”, i.e., it orders the parameter node sequence in document order without duplicates.

The four variable names $root, $dot, $pos, and $last, represent the document root node, context node, context position, and context size, respectively.

We note that the present invention exploits that all node selection reduced XPath Step expressions generated by normalization from full XPath expressions having either the form $Var/ForwardAxis::NodeTest or the form ddo($Var/ReverseAxis::NodeTest).

Subsequent to normalization, the context elimination module 308 eliminates all references to context position and size in the equivalent XPath expression 306 and replaces them with an expression for computing the context position and size from the context node. The result of the context elimination process of context elimination module 308 is equivalent XPath expression 310.

The normalization transformation of normalization module 304 makes use of the context size explicit in the sense that the value of the context size is computed and bound to a variable, e.g., $last in the equivalent XPath expression 306, as shown above. However, the context position is still implicitly bound in the core language by the at binder of the for expression form. The purpose of the context elimination transformation is to replace all uses of at by explicit computations of the context position using a let binding. This is achieved by: 1) keeping track of the defining step for every node sequence let variable in case the sequence is iterated over by a for expression, and 2) for every occurrence of at replace it with an explicit let binding to a computation of the index in the context sequence of that for expression.

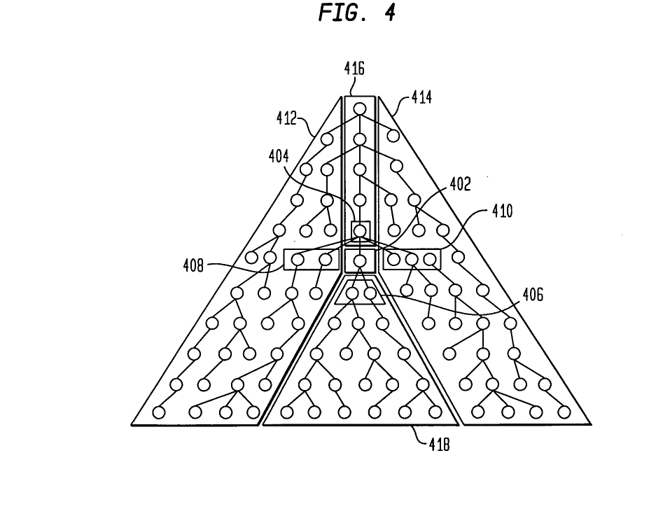

Note that the index can be recomputed for every node by using the XPath axis symmetries, as shown in FIG. 4, to explicitly count the nodes in the context sequence that occur before the context node. In addition there are a few cases where the XPath axis symmetries provide a more direct way to compute the count. FIG. 4 is an illustration of an XML binary tree showing axis partitions for a context node. FIG. 4 shows the context node 402, the parent 404 of the context node and the children 406 of the context node. FIG. 4 further shows the preceding siblings 408 of the context node and the following siblings 410 of the context node. Illustrating the symmetry of the binary tree, FIG. 4 further shows all nodes 412 preceding the context node and all nodes 414 following the context node. Also shown are all ancestor nodes 416 of the context node and all descendants 418 of the context node.

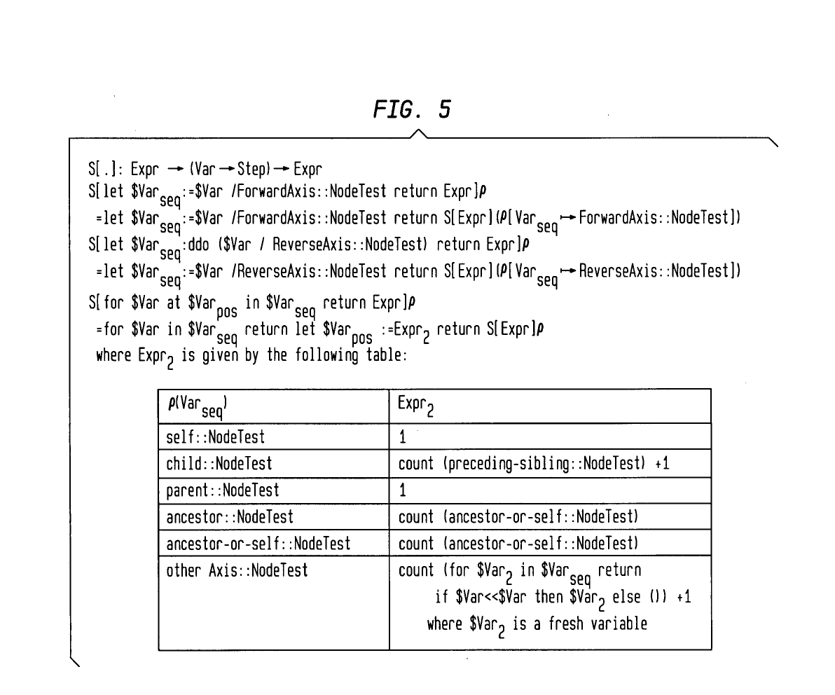

FIG. 5 is a representation of a derivor used for transforming an XPath expression in to a state-less form, in one embodiment of the present invention. A derivor is a structural recursive transformation formally defined below. FIG. 5 formally specifies the translation S such that S[[Expr]]Ø will transform the Expr expression (with Ø the empty environment) by defining the rules for translating S[[Expr]]ρ where: 1) the Expr parameter is the sub-expression that is rewritten by the rule (and since it is source language syntax, we surround it with the special “syntax” braces [[and]]), and 2) the additional parameter ρ maps all node sequence variables that are in scope to the axis and node-test used in the last step. Assertion 2) supports two operations: a) ρ [Var→Axis::NodeTest], which returns a new environment which is similar to the ρ environment except it includes a description that the Var variable is a node sequence constructed using the Axis::NodeTest step and b) ρ (Var), which denotes the most recent pair Axis::NodeTest added to the ρ environment for Var.

The definition of FIG. 5 uses the structural recursive specification style of denotational semantics where the transformation step of each expression is strictly defined in terms of transformations of sub-expressions. See the following texts for definitions of the structural recursive specification style of denotational semantics: D. A. Schmidt, Denotational Semantics, Allyn and Bacon, 1986, Logic and programming languages, CACM 20(9), 634-641, September 1977, and R. D. Tennent, The denotational semantics of programming languages, CACM 437-453, August 1976.

Furthermore, the transformation of FIG. 5 is only specified formally for the interesting (or pertinent) cases—all other expression forms are transformed to the simple reassembly of the transformed sub-terms. We have, for example, omitted the transformation rule:
S[[Expr₁+Expr₂]]ρ=S[[Expr₁]]ρ+S[[Expr₂]]ρ

Formally, this transformational rule can be explained by defining S as the homomorphic extension of the equations in FIG. 5 to the reduced XPath expression syntax. Applying the deriver S to the equivalent expression 306 transforms the expression into the stateless version of the equivalent expression 310 shown below:

```
ddo(
    let $seq := $root/descendant::employee
    return
      for $dot in $seq
      return
    let $seq := $dot/ancestor::manager
    return
        let $last := count($seq)
        return
            for $dot in $seq
            return
              let $rpos :=
                  count($dot/ancestor-or-self::manager)
              return
                  let $pos := $last − $rpos + 1
                  return
                        if $pos eq 1 then $dot else ( )
```

The transformation of module 308 left most of the expression intact, except for the single occurrence of at. The transformation performed the following two steps. In the first step, for every binding of a variable to a node sequence step computation, the ρ “environment” parameter is extended with a new Var declaration making it possible for the derivations on the sub-expressions to access the node sequence step declaration. For example, the fragment
let $seq :=ddo($dot/ancestor::manager)
return
   is not itself transformed but the derivation result of the following (sub)expression is passed an extended environment ρ that includes the binding $seq→ancestor::manager.

In the second step, for every for-expression with an at-binder, the binder is replaced with a let-binder with an appropriately-crafted expression to compute the context position based solely on the axis. Specifically, the fragment
for $dot at $rpos in $seq
return

with the variable and environment parameters above will be transformed to the fragment

```
for $dot in $seq
return
      let $rpos :=
            count($dot/ancestor-or-self::manager)
      return
```

which looks up that the context sequence $seq was defined by the step ancestor::manager and thus (from the table in FIG. 5) should be computed by counting the ancestors of the context node with the context node itself being first.

Returning to FIG. 3, subsequent to context elimination, the reverse axis elimination module 312 eliminates all steps involving a reverse axis in the equivalent XPath expression 310 and converts them to steps using the corresponding forward axis. The result of the reverse axis elimination process of reverse axis elimination module 312 is equivalent XPath expression 314.

The elimination of reverse axes also proceeds based on the symmetries illustrated in FIG. 4. That is, the nodes in the sequence constructed by the reverse axis are instead obtained by searching for ways to reach the context node from any node, using the symmetric forward axis. The search succeeds for a candidate reverse axis node if the intersection of the converse forward axis finds the context node from the candidate node. An important aspect of the invention is that the elimination of backward axes does not preserve the “context state.” It is beneficial that the context state has been eliminated first.

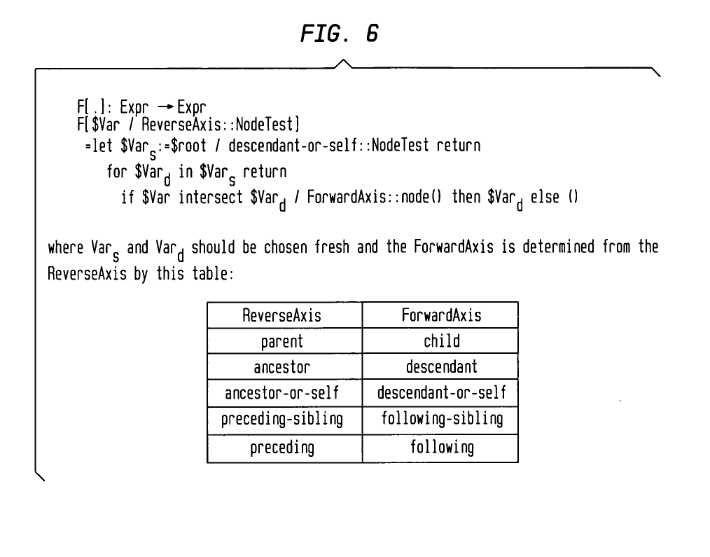

FIG. 6 is a representation of a derivor used for transforming an XPath expression in to a forward-only form, in one embodiment of the present invention. FIG. 6 formally specifies the transformation F for eliminating reverse axes (again we have only specified the interesting, or pertinent, cases, namely the translation of actual reverse steps—other cases are obtained by homomorphic extension). Applying F to our sample stateless expression 310 yields the expression 314 below, which uses no reverse axes:

```
ddo(
    let $seq := $root/descendant::employee
    return
      for $dot in $seq
      return
          let $seq :=
            let $managers := $root/descendant-or-self::manager
            return
                for $m in $managers
                return
                  if $d/descendant-or-self::node( ) intersect $dot
                  then $d else ( )
return
      let $last := count($seq)
      return
          for $dot in $seq
          return
            let $rpos := count(
                let $managers := $root/descendant-or-self::manager
                return
                  for $m in $managers
                  return
                      if $d/descendant-or-self::node( ) intersect $dot
                      then $d else ( )
      )
      return
          let $pos := $last − $rpos + 1
          return
            if $pos eq 1 then $dot else ( )
)
```

Observing the expression 314 above, we note that only the two steps with a reverse axis have changed. The fragment:
let $seq :=$dot/ancestor::manager
return

is transformed to

```
let $seq :=
      let $managers := $root/descendant-or-self::manager
      return
            for $m in $managers
            return
                  if $d/descendant-or-self::node( ) intersect $dot
                  then $d else ( )
      return
```

where the reverse axis has been replaced with a “forward search” that checks for each candidate manager element node checks whether the context node is among its descendants thence making the candidate an ancestor node of the context node. Similarly, the fragment:
let $rpos :=count($dot/ancestor-or-self::manager)

is transformed to

```
let $rpos := count(
      let $managers := $root/descendant-or-self::manager
      return
            for $m in $managers
            return
            if $d/descendant-or-self::node( ) intersect $dot
            then $d else ( )
)
```

Returning to FIG. 3, the processed XPath expression 314 is evaluated by the XPath processor 101 (see FIG. 1) upon streaming XML source data 316 to produce a node selection or value 318. The processing of streaming XML data by an XPath processor is described in greater detail with reference to FIG. 1 above.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

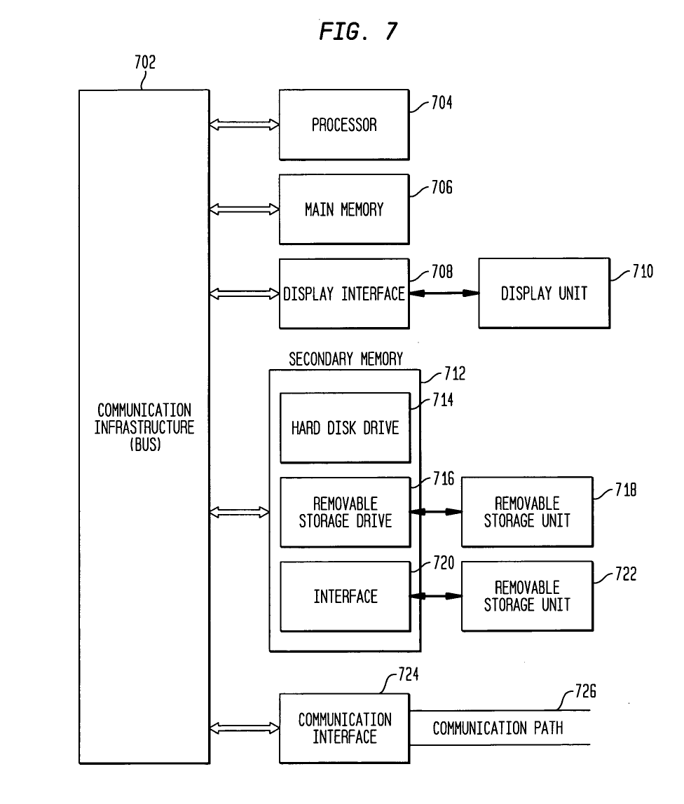

FIG. 7 is a high level block diagram showing an information processing system useful for implementing one embodiment of the present invention. The computer system includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, a compact disc, magnetic tape, optical disk, etc. which is read by and written to by removable storage drive 716. As will be appreciated, the removable storage unit 718 includes a computer readable medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method for processing a full XPath expression for evaluation over streaming XML data, the method comprising:
transforming the full XPath expression into an equivalent XPath expression written in a reduced XPath language;
transforming context position information in the equivalent XPath expression into an expression for computing the context position information; and
transforming reverse axis information in the equivalent XPath expression into forward axis information.

2. The method of claim 1, wherein the element of transforming the full XPath expression comprises:
transforming the full XPath expression into an equivalent XPath expression written in any one of Restricted XPaths—Rxp, STX and SXPath.

3. The method of claim 1, wherein the element of transforming the full XPath expression comprises:
transforming the full XPath expression into an equivalent XPath expression written in the XPath core language.

4. The method of claim 3, wherein the element of transforming context position information further comprises:
replacing all references to an “at” binder in the equivalent XPath expression with an explicit “let” binding to a computation of an index.

5. The method of claim 1, wherein the element of transforming context position information further comprises:
evaluating a derivor upon the equivalent XPath expression.

6. The method of claim 1, wherein the element of transforming reverse axis information further comprises:
calculating a path reaching a context node using a forward axis.

7. The method of claim 1, wherein the element of transforming reverse axis information further comprises:
evaluating a derivor upon the equivalent XPath expression.

8. An information processing system for processing a full XPath expression for evaluation over streaming XML data, comprising:
a memory for storing the full XPath expression; and
a processor configured to
transform the full XPath expression into an equivalent XPath expression written in a reduced XPath language;
transform context position information in the equivalent XPath expression into an expression for computing the context position information; and
transform reverse axis information in the equivalent XPath expression into forward axis information.

9. The information processing system of claim 8, further wherein the processor is configured by storing in memory instructions for:
transforming the full XPath expression into an equivalent XPath expression written in a reduced XPath language;
transforming context position information in the equivalent XPath expression into an expression for computing the context position information; and
transforming reverse axis information in the equivalent XPath expression into forward axis information.

10. The information processing system of claim 9, wherein the memory comprises a read-only memory.

11. The information processing system of claim 9, wherein the memory comprises a random-access memory.

12. The information processing system of claim 9, wherein the processor comprises an application specific integrated circuit.

13. The information processing system of claim 8, wherein the equivalent XPath expression is written in any one of the XPath core language, Restricted XPaths—Rxp, STX and SXPath.

14. The information processing system of claim 8, further comprising:
a memory for storing a derivor for transforming context position information in the equivalent XPath expression into an expression for computing the context position information.

15. The information processing system of claim 8, further comprising:
a memory for storing a derivor for transforming reverse axis information in the equivalent XPath expression into forward axis information.

16. A computer readable medium comprising a computer program product for processing a full XPath expression for evaluation over streaming XML data, the computer program product including instructions for:
transforming the full XPath expression into an equivalent XPath expression written in a reduced XPath language;
transforming context position information in the equivalent XPath expression into an expression for computing the context position information; and
transforming reverse axis information in the equivalent XPath expression into forward axis information.

17. The computer readable medium of claim 16, wherein the instructions for transforming the full XPath expression comprise instructions for:
transforming the full XPath expression into an equivalent XPath expression written in any one of Restricted XPaths—Rxp, STX and SXPath.

18. The computer readable medium of claim 16, wherein the instructions for transforming the full XPath expression comprise instructions for:
transforming the full XPath expression into an equivalent XPath expression written in the XPath core language.

19. The computer readable medium of claim 18, wherein the instructions for transforming context position information further comprise instructions for:
replacing all references to an “at” binder in the equivalent XPath expression with an explicit “let” binding to a computation of an index.

20. The computer readable medium of claim 16, wherein the instructions for transforming context position information further comprise instructions for:
evaluating a derivor upon the equivalent XPath expression.

21. The computer readable medium of claim 16, wherein the instructions for transforming reverse axis information further comprise instructions for:
calculating a path reaching a context node using a forward axis.

22. A method for processing an expression for evaluation over streaming XML data, the method comprising:
transforming the expression into an equivalent expression written in a reduced language;
transforming context position information in the equivalent expression into an expression for computing the context position information; and
transforming reverse axis information in the equivalent expression into forward axis information.

23. The method of claim 22, wherein the expression is written in any one of the XPath language and a language that allows access to and navigation in XML or similar tree-structured data based on relative and absolute positions and navigation.
